(19) United States
(12) Patent Application Publication
(10) Pub. No.: US 2016/0110015 A1
(43) Pub. Date: Apr. 21, 2016

(54) TOUCH PANEL SYSTEM AND ELECTRONIC DEVICE

(71) Applicant: SHARP KABUSHIKI KAISHA, Osaka (JP)

(72) Inventors: Mamoru TAKAYA, Osaka-shi (JP); Michiaki TAKEDA, Osaka-shi (JP)

(73) Assignee: SHARP KABUSHIKI KAISHA, Osaka-shi, Osaka (JP)

(21) Appl. No.: 14/893,622

(22) PCT Filed: May 28, 2014
(86) PCT No.: PCT/JP2014/064173

§ 371 Date: Nov. 24, 2015

(30) Foreign Application Priority Data
May 31, 2013 (JP) 2013-116253

(51) Int. Cl. G06F 3/041; G06F 3/0354

(52) U.S. Cl. CPC G06F 3/0416; G06F 3/03545

(57) ABSTRACT

A touch panel system includes a touch panel which includes a plurality of horizontal signal lines and a plurality of vertical signal lines, a touch panel controller which controls the touch panel, and a touch pen. The touch panel controller drives the horizontal signal lines in one of successive two frame periods and drives the horizontal signal lines or the vertical signal lines in the other of the frame periods, the touch pen outputs a state signal about a state of the touch pen in each frame period, and a first item representing a state of the touch pen is expressed by a plurality of state signals which are outputted in a plurality of successive frame periods.

### TECHNICAL FIELD

The present invention relates to a touch panel system and an electronic device.

### BACKGROUND ART

Patent literature 1 discloses such configuration that in a touch panel which includes a plurality of transmission electrode lines and a plurality of reception electrode lines which are orthogonal to the transmission electrode lines, a touch position of an electronic pen is detected based on output voltages, which are obtained by sequentially driving the transmission lines, of respective reception electrode lines and further discloses such configuration that an identification signal is transmitted from a touch pen (so-called electronic pen) to the touch panel.

### CITATION LIST

### Patent Literature

PTL 1: Japanese Unexamined Patent Application Publication No. 2012-022543 (Published on Feb. 2, 2012)

### SUMMARY OF INVENTION

### Technical Problem

An object of the present invention is to efficiently transmit a state signal from a touch pen to a touch panel.

### Solution to Problem

A touch panel system according to an aspect of the present invention includes a touch panel which includes a plurality of horizontal signal lines and a plurality of vertical signal lines, a touch panel controller which controls the touch panel, and a touch pen. In the touch panel system, the touch panel controller drives the horizontal signal lines in one of successive two frame periods and drives the horizontal signal lines or the vertical signal lines in the other of the frame periods, the touch pen outputs a state signal about a state of the touch pen in each frame period, and a first item representing a state of the touch pen is expressed by a plurality of state signals which are outputted in a plurality of successive frame periods.

According to the above-mentioned configuration, transmission of a state signal from the touch pen to the touch panel can be efficiently performed by setting an item, a slower response of which is permitted, to the first item, for example.

### Advantageous Effects of Invention

According to one aspect of the present invention, transmission of a state signal from a pen to a touch panel can be efficiently performed.

### BRIEF DESCRIPTION OF DRAWINGS

FIG. 1 is a schematic view illustrating the configuration of a touch panel system according to a first embodiment.

FIG. 2 is a schematic view illustrating the configuration of a touch panel of FIG. 1.

FIG. 3 is a schematic view illustrating the configuration of a touch pen of FIG. 1.

FIG. 4 is a table illustrating a relation between each bit of a state signal and a pulse signal.

FIG. 5 is a table illustrating a configuration example among types of a pen function, bit strings, and pulse signals.

FIG. 6 is a schematic view illustrating an operation of the touch panel system according to the first embodiment.

FIG. 7 is a timing diagram illustrating an operation of the touch panel system in a first pen function.

FIG. 8 is a timing diagram illustrating an operation of the touch panel system in a third pen function.

FIG. 9 is a table illustrating a relation between types of a pen function and bit strings.

FIG. 10 is a schematic view illustrating the configuration of a touch panel system according to a second embodiment.

FIG. 11 is a table illustrating a relation between each bit of a state signal and a pulse signal.

FIG. 12 is a table illustrating a relation among types of a pen function, bit strings, and pulse signals.

FIG. 13 is a schematic view illustrating an operation of the touch panel system according to the second embodiment.

FIG. 14 is a timing diagram illustrating an operation of the touch panel system in a first pen function.

FIG. 15 is a table illustrating a configuration example between types of a pen function and bit strings.

FIG. 16 is a table illustrating another configuration example between types of a pen function and bit strings.

FIG. 17 is a schematic view illustrating another configuration of the touch panel system according to the first embodiment.

FIG. 18 is a schematic view illustrating the configuration of a portable telephone according to a third embodiment.

### DESCRIPTION OF EMBODIMENTS

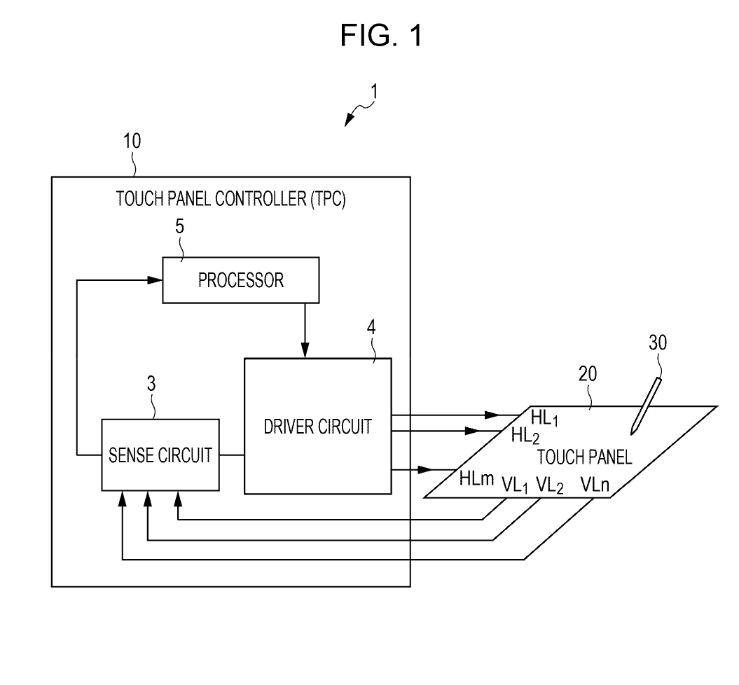

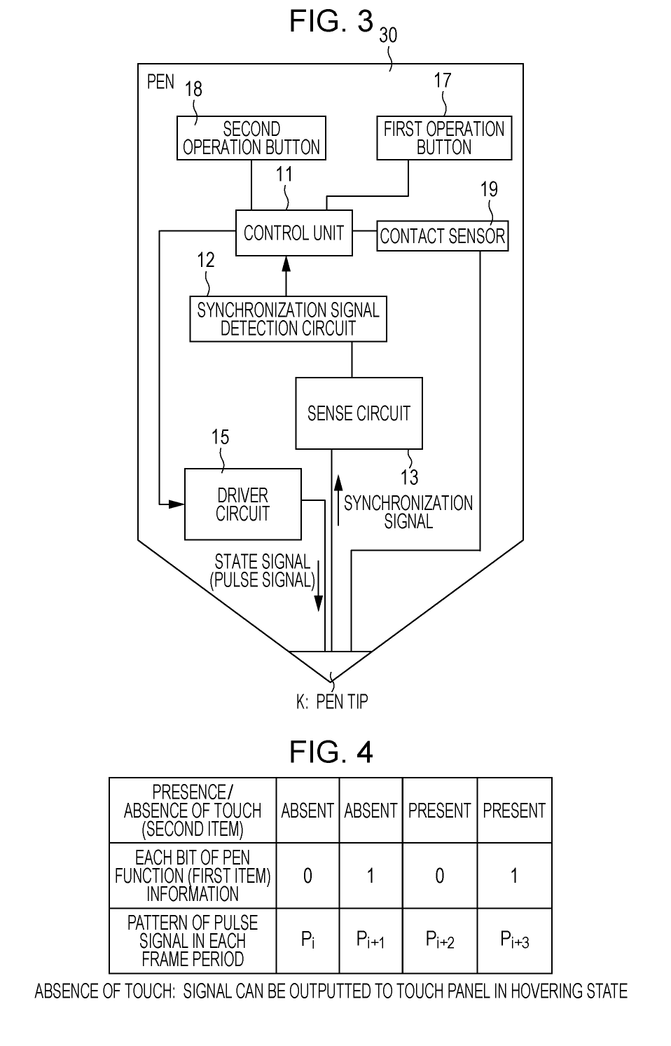

An embodiment of the present invention is described below with reference to FIG. 1 to FIG. 18.

### First Embodiment

(Configuration of touch panel system)

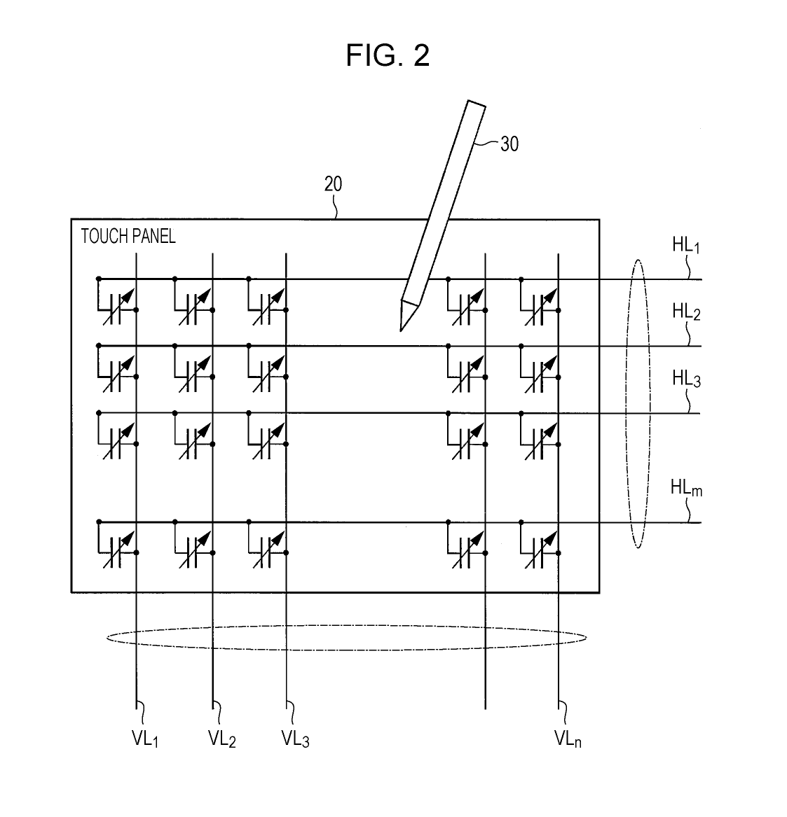

As illustrated in FIG. 1, a touch panel system 1 is provided with a touch panel 20, a touch pen (a stylus pen) 30, and a touch panel controller 10. On the touch panel 20, a plurality of horizontal signal lines HL1 to HLm and a plurality of vertical signal lines VL1 to VLn are provided, as illustrated in FIG. 2. One horizontal signal line (for example, HL1) intersects with n lines of vertical signal lines (VL1 to VLn) and capacitors are formed on n pieces of intersecting portions thus formed.

The touch panel controller 10 is provided with a processor 5, a driver circuit 4, and a sense circuit 3. In each frame period, the driver circuit 4 sequentially drives the horizontal signal lines HL1 to HLm in accordance with an instruction of the processor 5 and voltage signals which are sequentially outputted from the vertical signal lines (VL1 to VLn) in response to the driving of the horizontal signal lines HL1 to HLm are inputted into the sense circuit 3. Waveforms of these voltage signals are adjusted in the sense circuit 3 and the voltage signals are inputted into the processor 5. Further, in a synchronization period coming before each frame period, the driver circuit 4 simultaneously outputs synchronization signals to the horizontal signal lines HL1 to HLm in accordance with an instruction of the processor 5.

The touch pen 30 includes a control unit 11, a synchronization signal detection circuit 12, a sense circuit 13, a driver circuit 15, a first operation button 17, a second operation button 18, and a contact sensor 19. The contact sensor 19 recognizes presence/absence of contact between a pen tip K and the touch panel 20 and inputs touch information into the control unit 11. Further, pen function information obtained by combining a selection position of the first operation button 17 (ON/OFF) and a selection position of the second operation button 18 (including at least mode 1 and mode 2) is also inputted into the control unit 11.

Synchronization signals outputted from the touch panel controller 10 to the horizontal signal lines HL1 to HLm are detected at the synchronization signal detection circuit 12 via the pen tip K and the sense circuit 13 and are transmitted to the control unit 11. The control unit 11 controls the driver circuit 15 based on these synchronization signals, the above-mentioned pen function information (first item information), and the above-mentioned touch information (second item information), and accordingly, a state signal (a pulse signal) about a state of the touch pen 30 is outputted from the driver circuit 15. This state signal (pulse signal) is outputted after the horizontal signal line HLm is driven in each frame period.

Here, even in a non-touch state (hovering state) in which the pen tip K is separated from the touch panel 20, it is possible to receive a synchronization signal from the touch panel 20 and output a state signal to the touch panel 20 as long as the pen tip K is within an electrostatic limit.

The processor 5 of the touch panel controller 10 recognizes a position of a touch (a touch position) by the touch pen 30 and a state of the touch pen 30 based on voltage signals which are sequentially outputted from the vertical signal lines (VL1 to VLn) in each frame period.

### (Operation of Touch Panel System)

In the touch panel system 1, between a pen function (first item) and presence/absence of a touch (second item) which represent a state of the touch pen, the pen function, of which a response slower than that of the presence/absence of a touch is permitted, is expressed by a plurality of state signals which are outputted in a plurality of successive frame periods. Further, presence/absence of a touch of which a quick response is required is expressed by a state signal of each frame period.

In the touch panel system 1, the pen function information is expressed by a bit string obtained by combining two (2 bits) or more pieces of 0 or 1, and one bit is allocated per one frame. Namely, as illustrated in FIG. 4, a pattern of a state signal (a pulse signal) is set as Pi in a frame in which a touch is absent and an allocated bit is 0, a pattern of a state signal (a pulse signal) is set as Pi+1 in a frame in which a touch is absent and an allocated bit is 1, a pattern of a state signal (a pulse signal) is set as Pi+2 in a frame in which a touch is present and an allocated bit is 0, and a pattern of a state signal (a pulse signal) is set as Pi+3 in a frame in which a touch is present and an allocated bit is 1. That is, the number of types of a state signal (the number of patterns of a pulse signal) is four which is double the number of types (two types) of the second item.

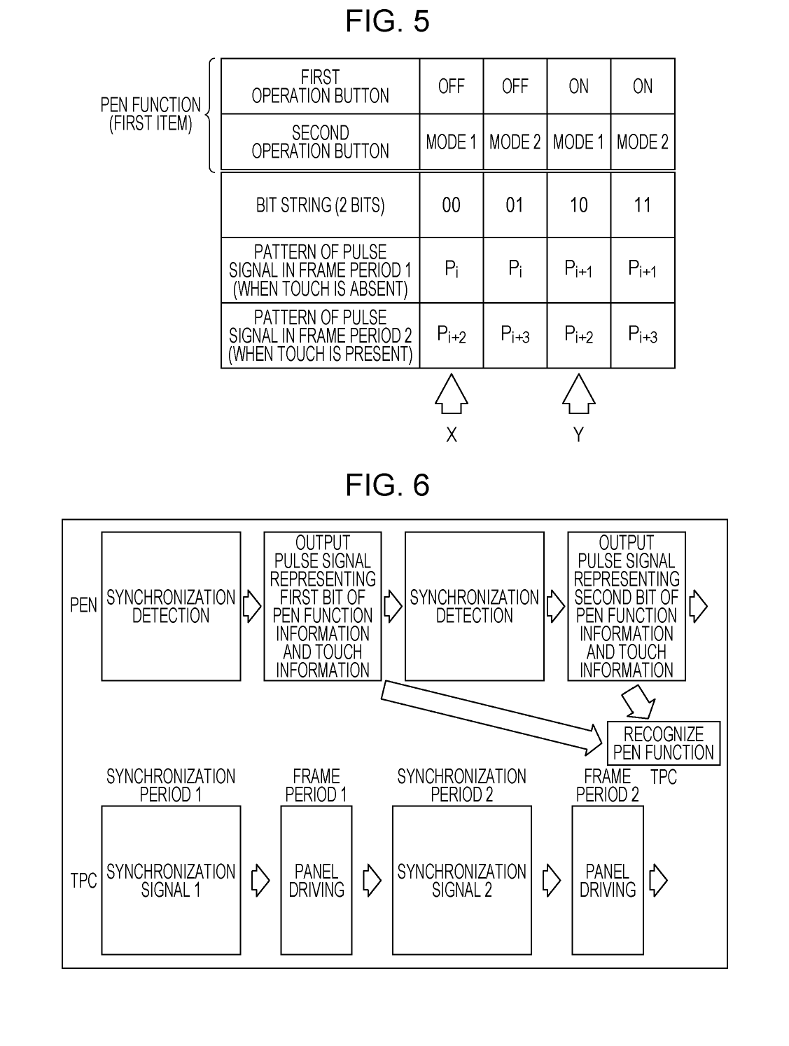

As illustrated in FIG. 5, in a case where there are first to fourth types of pen functions (second item) (a case where selection of the first operation button is OFF and selection of the second operation button is mode 1, a case where selection of the first operation button is OFF and selection of the second operation button is mode 2, a case where selection of the first operation button is ON and selection of the second operation button is mode 1, and a case where selection of the first operation button is ON and selection of the second operation button is mode 2), the first type is expressed by a bit string 00, the second type is expressed by a bit string 01, the third type is expressed by a bit string 10, and the fourth type is expressed by a bit string 11.

In this case, as illustrated in FIG. 6, the touch panel controller 10 outputs a synchronization signal 1 to the horizontal signal lines HL1 to HLm and the touch pen 30 receives the synchronization signal 1 via the pen tip K in a synchronization period 1. In a frame period 1 following the synchronization period 1, after the touch panel controller 10 sequentially drives the horizontal signal lines HL1 to HLm, the touch pen 30 outputs a pulse signal which represents the first bit (left side) of pen function information (2 bits) and presence/absence of a touch.

In a synchronization period 2 following the frame period 1, the touch panel controller 10 outputs a synchronization signal 2 to the horizontal signal lines HL1 to HLm and the touch pen 30 receives the synchronization signal 2 via the pen tip K. In a frame period 2 following the synchronization period 2, after the touch panel controller 10 sequentially drives the horizontal signal lines HL1 to HLm, the touch pen 30 outputs a pulse signal which represents the second bit (right side) of the pen function information (2 bits) and presence/absence of a touch. When these frame periods 1 and 2 are ended, the touch panel controller 10 can recognize the pen function.

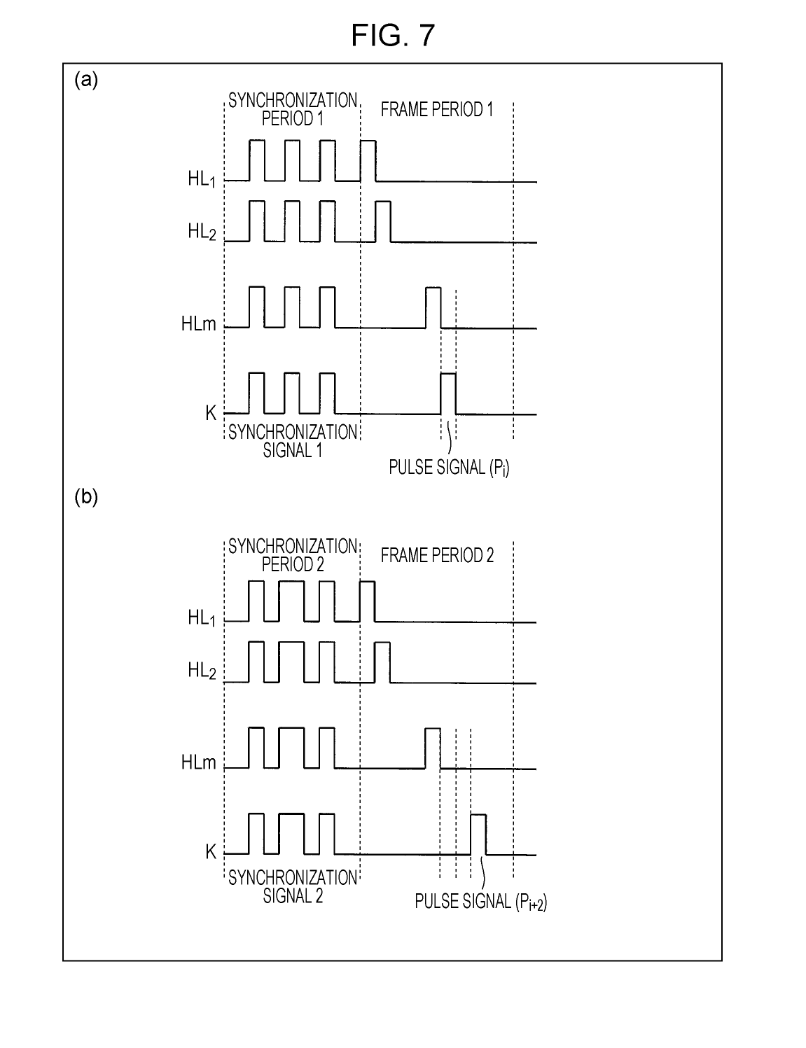

For example, when the pen function is the first type (the case where selection of the first operation button is OFF and selection of the second operation button is mode 1), further a touch is absent in the frame period 1, and a touch is present in the frame period 2 (refer to X of FIG. 5), a pulse signal of pattern Pi (a pulse signal which rises in synchronization with the fall of a driving pulse of the HLm) is outputted in the frame period 1 as illustrated in FIG. 7(a) and a pulse signal of pattern Pi+2 (a pulse signal which rises two pulses behind the fall of the driving pulse of the HLm) is outputted in the frame period 2 as illustrated in FIG. 7(b). The pulse signal of pattern Pi rises in synchronization with the fall of the driving pulse of the HLm. However, this is merely an example and such waveform that the pulse signal rises after the elapse of a predetermined period may be employed.

The touch panel controller 10 recognizes that a touch is absent based on the pulse signal of pattern Pi after the end of the frame period 1, recognizes that a touch is present based on the pulse signal of pattern Pi+2 after the end of the frame period 2, and further recognizes that the pen function is the first type based on the pulse signal of pattern Pi and the pulse signal of pattern Pi+2 after the end of the frame periods 1 and 2.

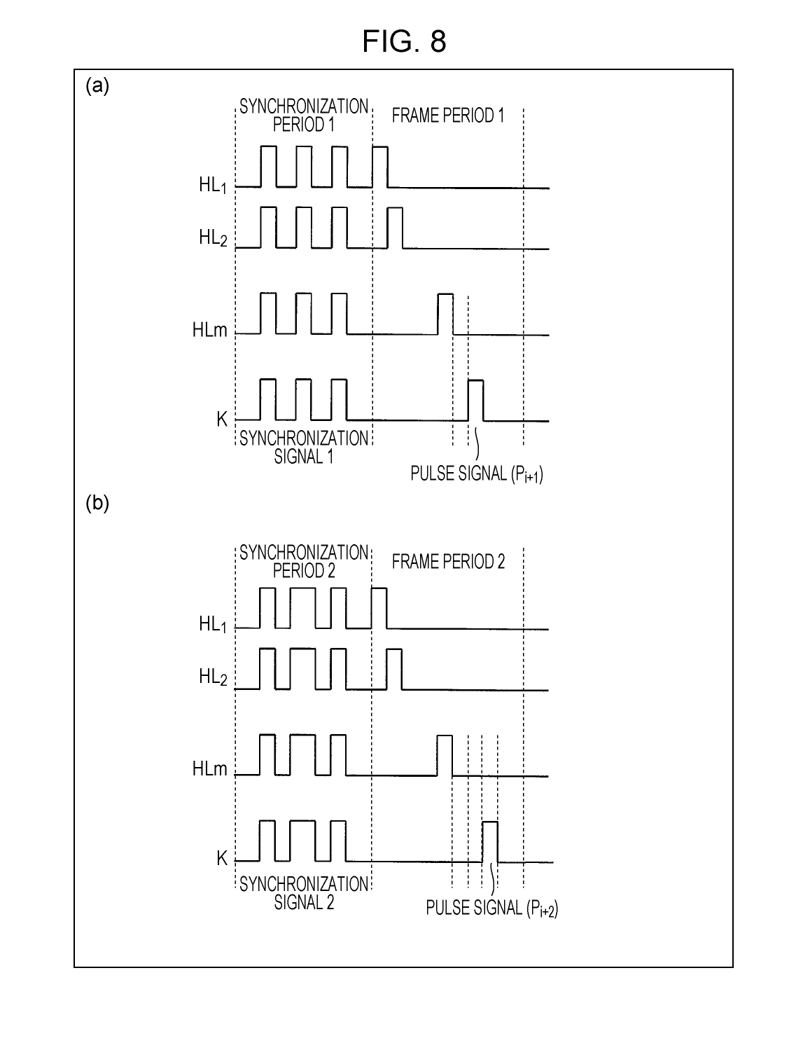

Further, when the pen function is the third type (the case where selection of the first operation button is ON and selection of the second operation button is mode 1), further a touch is absent in the frame period 1, and a touch is present in the frame period 2 (refer to Y of FIG. 5), a pulse signal of pattern Pi+1 (a pulse signal which rises one pulse behind the fall of a driving pulse of the HLm) is outputted in the frame period 1 as illustrated in FIG. 8(a) and a pulse signal of pattern Pi+2 (a pulse signal which rises two pulses behind the fall of the driving pulse of the HLm) is outputted in the frame period 2 as illustrated in FIG. 8(b).

The touch panel controller 10 recognizes that a touch is absent based on the pulse signal of pattern Pi+1 after the end of the frame period 1, recognizes that a touch is present based on the pulse signal of pattern Pi+2 after the end of the frame period 2, and further recognizes that the pen function is the third type based on the pulse signal of pattern Pi+1 and the pulse signal of pattern Pi+2 after the end of the frame periods 1 and 2.

Here, patterns of the synchronization signals 1 and 2 are different from each other as illustrated in FIGS. 8(a) and (b), so that the touch panel controller 10 can recognize that the pulse signal of pattern Pi represents the first bit (left side: 1) of the pen function information and the pulse signal of pattern Pi+2 represents the second bit (right side: 0) of the pen function information.

Here, 00, 01, 10, and 11 are used as bit strings of two bits and the synchronization signals 1 and 2 have different patterns from each other so as to discriminate 10 and 01, in FIG. 5 and FIG. 6. In a case where the pen function is expressed by bit strings of three bits (000 and 111, for example), the number of types of synchronization patterns is increased to three types (synchronization patterns 1, 2, and 3) or synchronization patterns are arrayed as 1, 2, 2, 1, so as to recognize a bit order.

In a case where the synchronization signals 1 and 2 are set to mutually have identical patterns, bit strings to be used may be set as 00, 01, and 11 (the number of types of the pen function which can be expressed is three) so as to enable recognition of the pen function regardless of reception timing even when the bit strings are repeated. In a case where synchronization signals are set to mutually have identical patterns in bit strings of three bits, 000, 001, 011, and 111 (the number of types of the pen function which can be expressed is four) may be used. In a case where synchronization signals are set to mutually have identical patterns in bit strings of four bits, 0000, 0001, 0011, 0101, 0111, and 1111 (the number of types of the pen function which can be expressed is six) may be used.

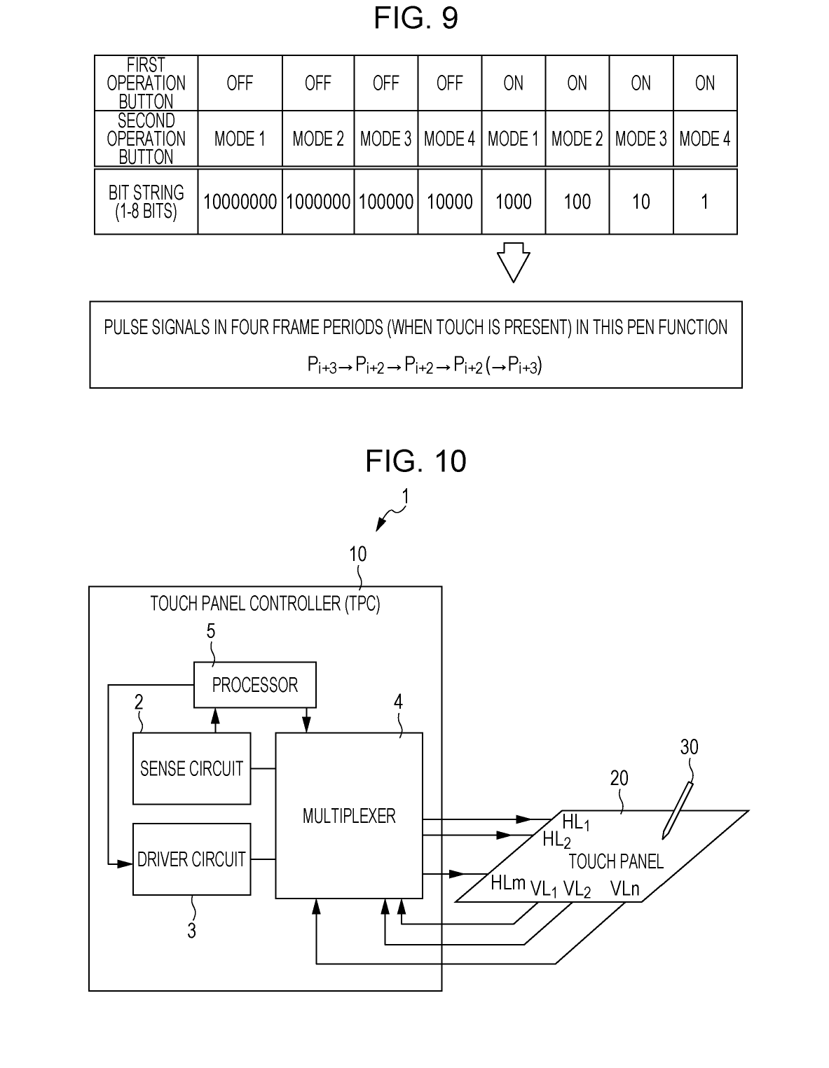

In a case where the synchronization signals 1 and 2 are set to mutually have identical patterns, the types of the pen function may be set to the first to eighth types, a bit string 10000000 may be allocated to the first type, a bit string 1000000 may be allocated to the second type, a bit string 100000 may be allocated to the third type, a bit string 10000 may be allocated to the fourth type, a bit string 1000 may be allocated to the fifth type, a bit string 100 may be allocated to the sixth type, a bit string 10 may be allocated to the seventh type, and a bit string 1 may be allocated to the eighth type, as illustrated in FIG. 9. For example, when the pen function is the fifth type (the case where selection of the first operation button is ON and selection of the second operation button is mode 1) and presence of a touch continues for four frames, a pattern of a pulse signal of the touch pen 30 becomes Pi+3→Pi+2→Pi+2→Pi+2(→Pi+3). Three pulse signals of pattern Pi+2 (bit 0) are present between a pulse signal of pattern Pi+3 (bit 1) and a next pulse signal of pattern Pi+3 (bit 1), so that the touch panel controller 10 can recognize that the type of the pen function is the third type.

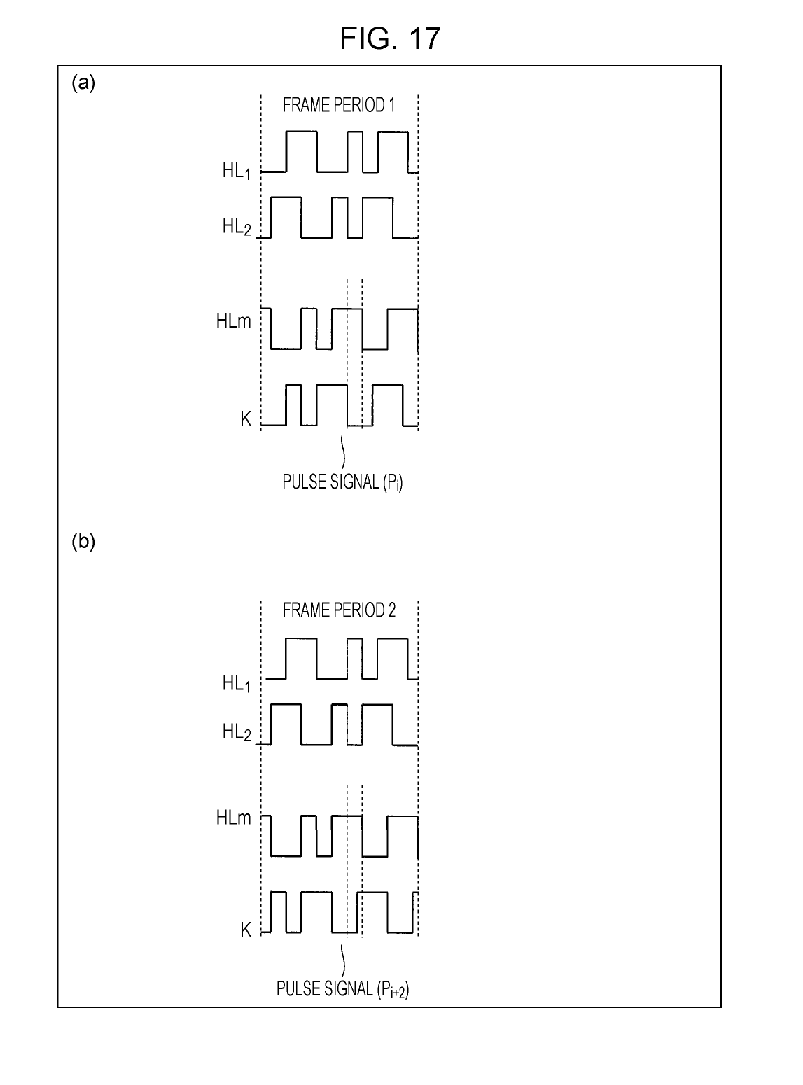

The horizontal signal lines HL1 to HLm are sequentially driven in each frame period as illustrated in FIG. 7 in the first embodiment, but the configuration is not limited to this. As illustrated in FIG. 17, such configuration may be employed that the horizontal signal lines HL1 to HLm are driven in parallel in each of the frame period 1 and the frame period 2, the touch pen 30 outputs a pulse signal (for example, pattern Pi) in the frame period 1 (refer to FIG. 17(a)), and the touch pen 30 outputs a pulse signal (for example, pattern Pi+2) in the frame period 2 (refer to FIG. 17(b)).

### Second Embodiment

### (Configuration of Touch Panel System)

As illustrated in FIG. 10, a touch panel system 1 is provided with a touch panel 20, a touch pen (a stylus pen) 30, and a touch panel controller 10. The configuration of the touch panel 20 is same as that of the first embodiment.

The touch panel controller 10 is provided with a processor 5, a driver circuit 4, a sense circuit 3, and a multiplexer 4. The multiplexer 4 connects a plurality of horizontal signal lines HL1 to HLm to the driver circuit 3 and connects a plurality of vertical signal lines (VL1 to VLn) to the sense circuit 2 in uneven-number frame periods and synchronization periods coming ahead the uneven-number frame periods, while the multiplexer 4 connects a plurality of vertical signal lines (VL1 to VLn) to the driver circuit 3 and connects a plurality of horizontal signal lines HL1 to HLm to the sense circuit 2 in even-number frame periods and synchronization periods coming ahead the even-number frame periods.

In uneven-number frame periods, the driver circuit 4 sequentially drives the horizontal signal lines HL1 to HLm in accordance with an instruction of the processor 5 and voltage signals which are sequentially outputted from the vertical signal lines (VL1 to VLn) in response to the driving of the horizontal signal lines HL1 to HLm are inputted into the sense circuit 3. In even-number frame periods, the driver circuit 4 sequentially drives the vertical signal lines (VL1 to VLn) in accordance with an instruction of the processor 5 and voltage signals which are sequentially outputted from the horizontal signal lines HL1 to HLm in response to the driving of the vertical signal lines (VL1 to VLn) are inputted into the sense circuit 3. Waveforms of these voltage signals are adjusted in the sense circuit 3 and the voltage signals are inputted into the processor 5.

Further, in synchronization periods coming ahead uneven-number frame periods, the driver circuit 4 outputs synchronization signals to the horizontal signal lines HL1 to HLm in parallel in accordance with an instruction of the processor 5, while in synchronization periods coming ahead even-number frame periods, the driver circuit 4 outputs synchronization signals to the vertical signal lines (VL1 to VLn) in parallel in accordance with an instruction of the processor 5. Here, synchronization signals can be outputted to the vertical signal lines VL1 to VLn and the horizontal signal lines HL1 to HLm respectively before each frame period, can be outputted to the vertical signal lines VL1 to VLn before each frame period, and can be outputted to the horizontal signal lines HL1 to HLm before each frame period.

The configuration of the touch pen 30 is same as that of the first embodiment.

In uneven-number frame periods, synchronization signals outputted to the horizontal signal lines HL1 to HLm are detected at the synchronization signal detection circuit 12 via the pen tip K and the sense circuit 13 and are transmitted to the control unit 11. The control unit 11 controls the driver circuit 15 based on these synchronization signals, the above-mentioned pen function information (first item information), and the above-mentioned touch information (second item information), and accordingly, a state signal (a pulse signal) representing a state of the touch pen 30 is outputted from the driver circuit 15. This state signal (pulse signal) is outputted after the horizontal signal line HLm is driven in each frame period.

In even-number frame periods, synchronization signals outputted to the vertical signal lines (VL1 to VLn) are detected at the synchronization signal detection circuit 12 via the pen tip K and the sense circuit 13 and are transmitted to the control unit 11. The control unit 11 controls the driver circuit 15 based on these synchronization signals, the above-mentioned pen function information (first item information), and the above-mentioned touch information (second item information), and accordingly, a state signal (a pulse signal) representing a state of the touch pen 30 is outputted from the driver circuit 15. This state signal (pulse signal) is outputted after the vertical signal line VLn is driven in each frame period.

The processor 5 of the touch panel controller 10 recognizes a position of a touch (a touch position) by the touch pen 30 and a state of the touch pen 30 based on voltage signals which are sequentially outputted from the vertical signal lines (VL1 to VLn) or the horizontal signal lines (HL1 to HLm) in each frame period.

### (Operation of Touch Panel System)

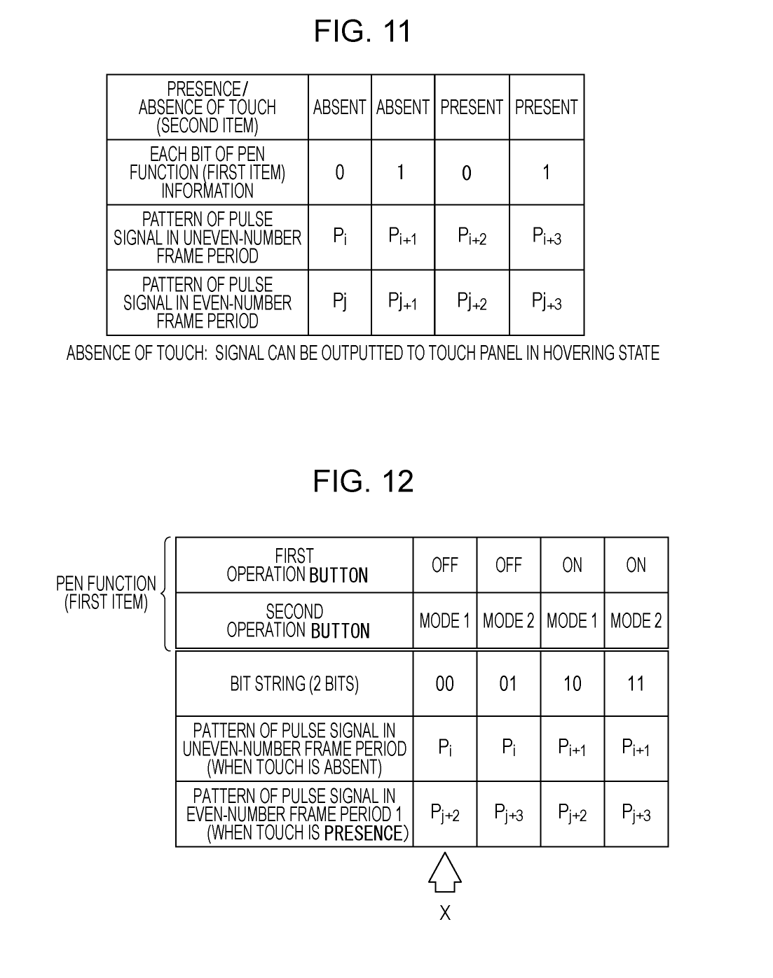

In the touch panel system 1, pen function information is expressed by a bit string obtained by combining two (2 bits) or more pieces of 0 or 1, and one bit is allocated per one frame. Namely, as illustrated in FIG. 11, a pattern of a state signal (a pulse signal) is set as Pi (an uneven-number frame) or Pj (an even-number frame) in a frame in which a touch is absent and an allocated bit is 0, a pattern of a state signal (a pulse signal) is set as Pi+1 (an uneven-number frame) or Pj+1 (an even-number frame) in a frame in which a touch is absent and an allocated bit is 1, a pattern of a state signal (a pulse signal) is set as Pi+2 (an uneven-number frame) or Pj+2 (an even-number frame) in a frame in which a touch is present and an allocated bit is 0, and a pattern of a state signal (a pulse signal) is set as Pi+3 (an uneven-number frame) or Pj+3 (an even-number frame) in a frame in which a touch is present and an allocated bit is 1.

As illustrated in FIG. 12, in a case where there are first to fourth types of pen functions (second items) (a case where selection of the first operation button is OFF and selection of the second operation button is mode 1, a case where selection of the first operation button is OFF and selection of the second operation button is mode 2, a case where selection of the first operation button is ON and selection of the second operation button is mode 1, and a case where selection of the first operation button is ON and selection of the second operation button is mode 2), the first type is expressed by a bit string 00, the second type is expressed by a bit string 01, the third type is expressed by a bit string 10, and the fourth type is expressed by a bit string 11.

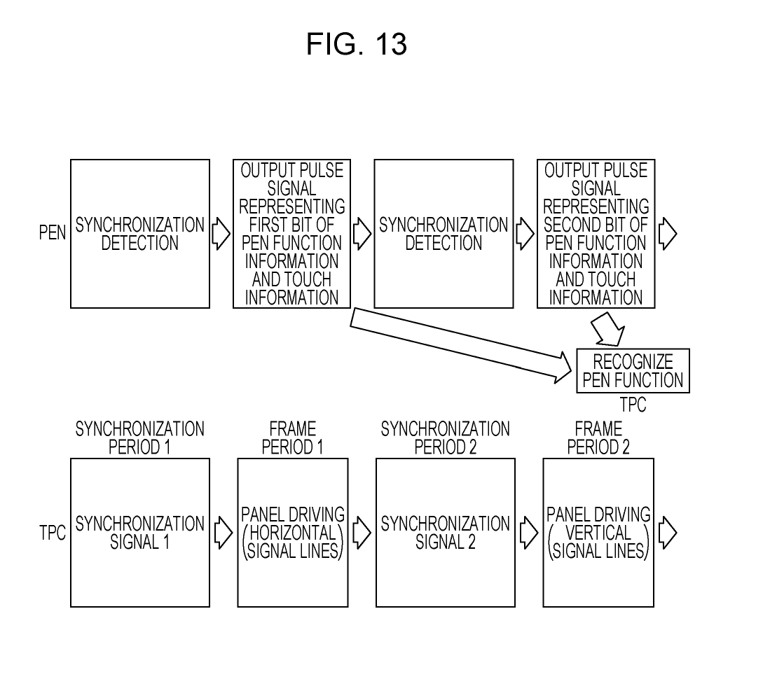

In this case, as illustrated in FIG. 13, the touch panel controller 10 outputs a synchronization signal 1 to the horizontal signal lines HL1 to HLm and the touch pen 30 receives the synchronization signal 1 via the pen tip K in a synchronization period 1. In a frame period 1 following the synchronization period 1, after the touch panel controller 10 sequentially drives the horizontal signal lines HL1 to HLm, the touch pen 30 outputs a pulse signal which represents the first bit (left side) of pen function information (2 bits) and presence/absence of a touch.

In a synchronization period 2 following the frame period 1, the touch panel controller 10 outputs a synchronization signal 2 to the vertical signal lines VL1 to VLn and the touch pen 30 receives the synchronization signal 2 via the pen tip K. In a frame period 2 following the synchronization period 2, after the touch panel controller 10 sequentially drives the vertical signal lines VL1 to VLn, the touch pen 30 outputs a pulse signal which represents the second bit (right side) of the pen function information (2 bits) and presence/absence of a touch. When these frame periods 1 and 2 are ended, the touch panel controller 10 can recognize the pen function.

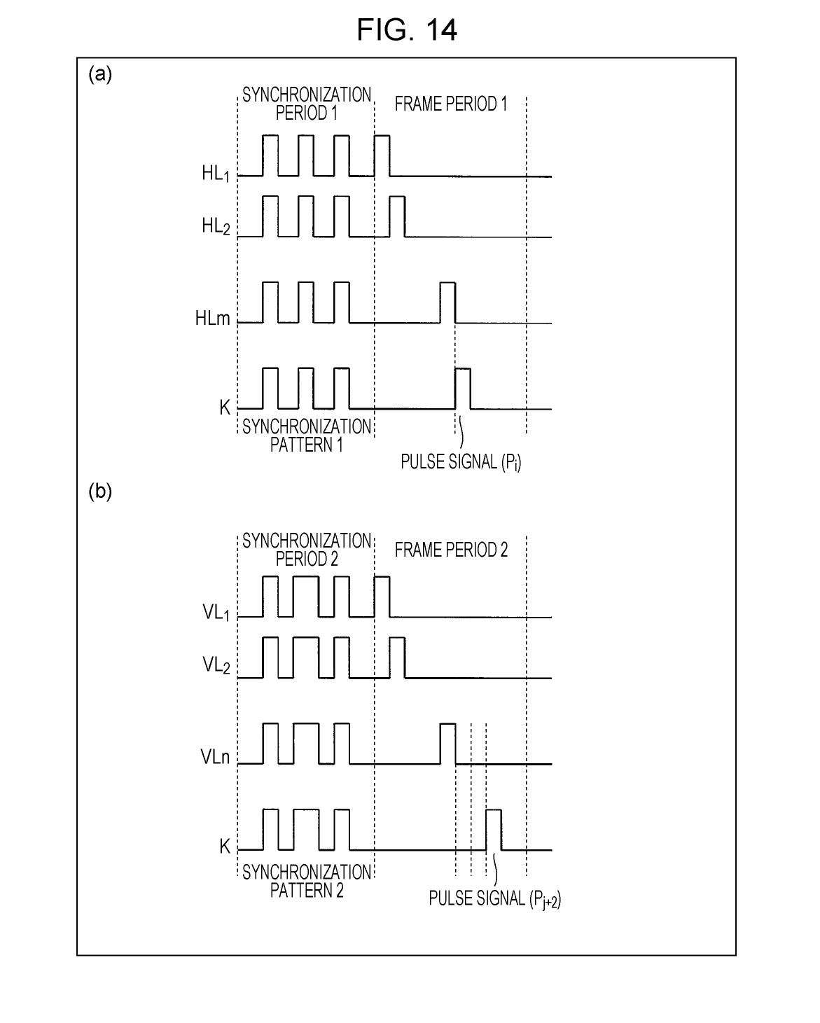

For example, when the pen function is the first type (the case where selection of the first operation button is OFF and selection of the second operation button is mode 1), further a touch is absent in the frame period 1, and a touch is present in the frame period 2 (refer to X of FIG. 5), a pulse signal of pattern Pi (a pulse signal which rises in synchronization with the fall of a driving pulse of the HLm) is outputted in the frame period 1 as illustrated in FIG. 14(a) and a pulse signal of pattern Pj+2 (a pulse signal which rises two pulses behind of fall of the driving pulse of the VLn) is outputted in the frame period 2 as illustrated in FIG. 14(b).

The touch panel controller 10 recognizes that a touch is absent based on the pulse signal of pattern Pi after the end of the frame period 1, recognizes that a touch is present based on the pulse signal of pattern Pj+2 after the end of the frame period 2, and further recognizes that the pen function is the first type based on the pulse signal of pattern Pi and the pulse signal of pattern Pj+2 after the end of the frame periods 1 and 2.

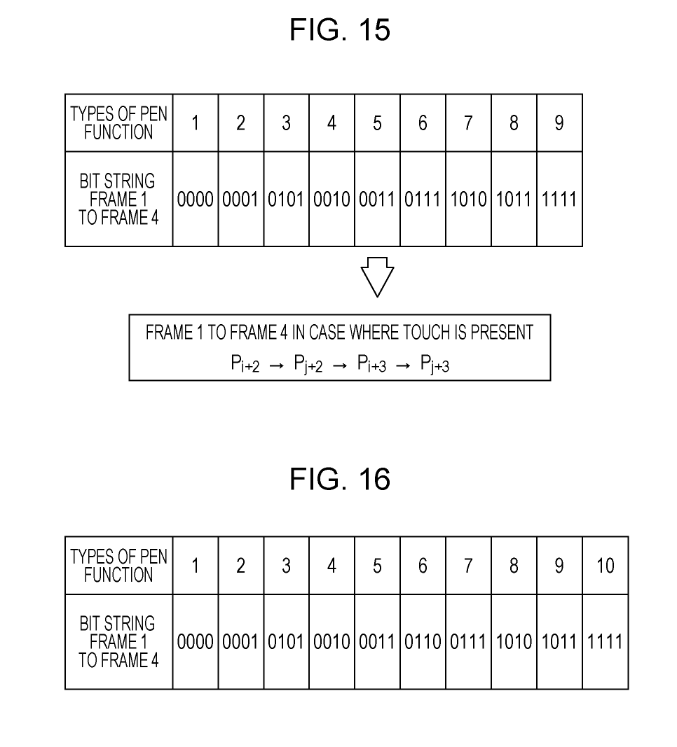

Further, in the second embodiment, in a case where the bit string has four bits and the number of types of patterns of a synchronization signal is two (one type for each of an uneven-number frame period and an even-number frame period), by using 00, 01, and 11 for each of the uneven-number frame period and the even-number frame period, the pen function can be recognized regardless of reception timing even though bit strings are repeated. That is, the first to ninth types of pen functions can be expressed by four-bit strings. In particular, as illustrated in FIG. 15, 0000 is allocated to the first type, 0001 is allocated to the second type, 0101 is allocated to the third type, 0010 is allocated to the fourth type, 0011 is allocated to the fifth type, 0111 is allocated to the sixth type, 1010 is allocated to the seventh type, 1011 is allocated to the eighth type, and 1111 is allocated to the ninth type. In this case, when the pen function is the fifth type and presence of a touch continues for four frame periods, for example, a pattern of a pulse signal of the touch pen 30 becomes Pi+2→Pj+2→Pi+3→Pj+3. Accordingly, the number of types of pen functions which can be expressed can be increased more than six types of a case in which the pen function is expressed simply by four bits.

Further, in a case where a bit order can be specified in an uneven-number frame period, states which can be expressed by N bits are all available in an even-number frame period. In a case of a two-bit string, orders of bits of 00 and 11 are indefinite, but a bit order of 01 is specified. Therefore, four patterns of 00, 01, 10, and 11 can be used in even-number frame periods when 01 is used in an uneven-number frame period. As a result, a total of 10 types obtained by 3+4+3 can be expressed in four frames (an uneven number and an even number may be reversed).

In particular, as illustrated in FIG. 16, 0000 is allocated to the first type, 0001 is allocated to the second type, 0101 is allocated to the third type, 0010 is allocated to the fourth type, 0011 is allocated to the fifth type, 0110 is allocated to the sixth type, 0111 is allocated to the seventh type, 1010 is allocated to the eighth type, 1011 is allocated to the ninth type, and 1111 is allocated to the tenth type. Accordingly, the number of types of pen functions which can be expressed can be increased more than a case in which the pen function is expressed simply by four bits (six types). More types of pen functions can be expressed in a case of N bits as well by applying the similar thought.

### Third Embodiment

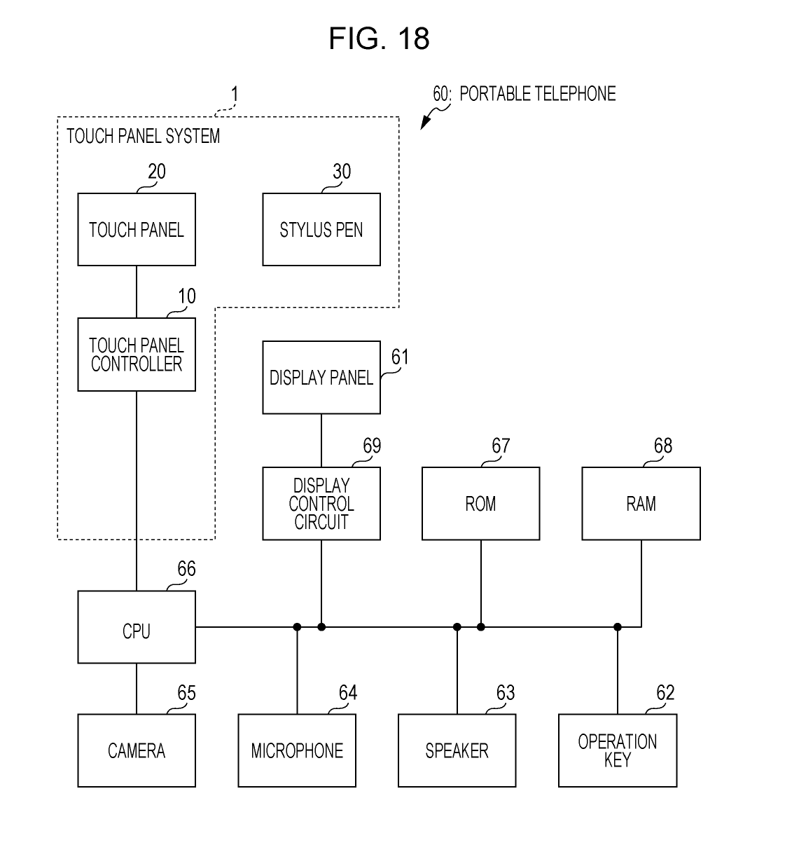

In a third embodiment, a case where a touch panel system 1 is mounted on a mobile telephone serving as an electronic device is described with reference to FIG. 18. A portable telephone 60 is provided with the touch panel system 1, a display panel 61, an operation key 62, a speaker 63, a microphone 64, a camera 65, a CPU 66, a ROM 67, a RAM 68, and a display control circuit 69, as illustrated in FIG. 18. Respective constituent elements are mutually connected by a data bus.

As described above, the touch panel system 1 includes a touch panel 20, a touch panel controller 10, and a touch pen 30.

The display panel 61 displays an image which is stored in the ROM 67 and the RAM 68, by the display control circuit 69. Further, the display panel 61 is superposed on the touch panel 20 or incorporates the touch panel 20. Here, a touch recognition signal which is generated by a touch recognition unit 17 and represents a touch position on the touch panel 20 may be allowed to serve as a signal which represents that the operation key 62 is operated.

The operation key 62 receives an input of an instruction by a user of the portable telephone 60.

The speaker 63 outputs a sound based on music data and the like which are stored in the RAM 68, for example.

The microphone 64 receives an input of a voice of the user. The portable telephone 60 digitalizes the inputted voice (analog data). Then, the portable telephone 60 transmits the digitalized voice to a communication partner (for example, another portable telephone).

The camera 65 photographs an object in response to an operation of the operation key 62 operated by the user. Here, image data of the photographed object is stored in the RAM 68 or an external memory (for example, a memory card).

The CPU 66 controls operations of the touch panel system 1 and the portable telephone 60. The CPU 66 executes a program stored in the ROM 67, for example.

The ROM 67 stores data in a nonvolatile manner. Further, the ROM 67 is a ROM, such as an erasable programmable read-only memory (EPROM) and a flash memory, which is writable and erasable. Not illustrated in FIG. 18, such configuration that the portable telephone 60 includes an interface (IF) by which the portable telephone 60 is connected with other electronic devices by wire may be employed.

The RAM 68 stores data which is generated through execution of a program by the CPU 66 or data which is inputted via the operation key 62 in a volatile manner.

Thus, the portable telephone 60 as an electronic device according to the present embodiment includes the touch panel system 1. Accordingly, the portable telephone 60 as an electronic device which is provided with the touch panel system 1 which is capable of detecting a synchronization signal in a qualified manner can be provided.

### SUMMARY

The touch panel system is characterized in that the touch panel system includes a touch panel which includes a plurality of horizontal signal lines and a plurality of vertical signal lines, a touch panel controller which controls the touch panel, and a touch pen, the touch panel controller drives the horizontal signal lines in one of successive two frame periods and drives the horizontal signal lines or the vertical signal lines in the other of the frame periods, the touch pen outputs a state signal about a state of the touch pen in each frame period, and a first item representing a state of the touch pen is expressed by a plurality of state signals which are outputted in a plurality of successive frame periods.

In the touch panel system, such configuration may be employed that a second item representing a state of the touch pen is an item a response of which is required to be quicker than that of the first item and the second item is expressed by a state signal of each frame period.

In the touch panel system, such configuration may be employed that the touch panel controller outputs a synchronization signal to the touch panel before each frame period and the touch pen receives the synchronization signal via the touch panel.

In the touch panel system, such configuration may be employed that the state signal is a pulse signal having a pattern which corresponds to a state of the touch pen.

In the touch panel system, such configuration may be employed that the first item is an item representing a function of a pen and the second item is an item representing presence/absence of a contact between a pen tip and the touch panel.

In the touch panel system, such configuration may be employed that the number of types of a state signal which is outputted by the touch pen is double the number of types of the second item.

In the touch panel system, such configuration may be employed that when the number of types of the first item is the X-th (X is an integer which is 2 or larger) power of 2, the plurality of successive frame periods are X pieces of frame periods.

In the touch panel system, such configuration may be employed that there are a plurality of types of first items and the number of the plurality of successive frame periods differs for each of the types.

The electronic device is characterized in that the electronic device is provided with the touch panel system.

### INDUSTRIAL APPLICABILITY

For example, the present invention is available for an electronic blackboard and a portable telephone.

### REFERENCE SIGNS LIST

1 touch panel system
10 touch panel controller (TPC)
20 touch panel
30 pen (stylus pen)

1. A touch panel system comprising:
a touch panel which includes a plurality of horizontal signal lines and a plurality of vertical signal lines;
a touch panel controller which controls the touch panel; and
a touch pen; wherein
the touch panel controller drives the horizontal signal lines in one of successive two frame periods and drives the horizontal signal lines or the vertical signal lines in the other of the frame periods,
the touch pen outputs a state signal about a state of the touch pen in each frame period, and
a first item representing a state of the touch pen is expressed by a plurality of state signals which are outputted in a plurality of successive frame periods.

2. The touch panel system according to claim 1, wherein
a second item representing a state of the touch pen is an item a response of which is required to be quicker than that of the first item, and
the second item is expressed by a state signal of each frame period.

3. The touch panel system according to claim 1, wherein the touch panel controller outputs a synchronization signal to the touch panel before each frame period and the touch pen receives the synchronization signal via the touch panel.

4. The touch panel system according to claim 1, wherein when the number of types of the first item is the X-th power of 2, where X is an integer which is 2 or larger, the plurality of successive frame periods are X pieces of frame periods.

5. The touch panel system according to claim 1, wherein there are a plurality of types of first items and the number of the plurality of successive frame periods differs for each of the types.
